(19) United States
(12) Patent Application Publication
(10) Pub. No.: US 2007/0234114 A1
(43) Pub. Date: Oct. 4, 2007

(54) Method, apparatus, and computer program product for implementing enhanced performance of a computer system with partially degraded hardware

(75) Inventors: Sheldon Ray Bailey, Rochester, MN (US); Alwood Patrick Williams III, Rochester, MN (US)

Correspondence Address: IBM CORPORATION;ROCHESTER IP LAW DEPT 917, 3605 HIGHWAY 52 N, ROCHESTER, MN, 55901-7829, US

(73) Assignee: INTERNATIONAL BUSINESS MACHINES CORPORATION, ARMONK, NY (US)

(21) Appl. No.: 11/393,141

(22) Filed: Mar. 30, 2006

(51) Int. Cl. G06F 11/00

(52) U.S. Cl. 714/13

(57) ABSTRACT

Enhanced performance is provided for a computer system with partially degraded hardware. A performance deconfiguration event is identified for a hardware item. The hardware item is marked in a performance deconfiguration state. When there is at least one fully working spare available for the hardware item of the performance deconfiguration event, then a fully working spare is activated. Then the hardware item is moved to a performance degraded hardware pool after the fully working spare is activated.

### FIELD OF THE INVENTION

The present invention relates generally to the data processing field, and more particularly, relates to a method, apparatus and computer program product for implementing enhanced performance of a computer system with partially degraded hardware.

### DESCRIPTION OF THE RELATED ART

Known computer systems have the ability to deconfigure hardware items once diagnostics determined that a hardware item is in a degraded state. Such computer systems have the ability to deconfigure hardware on the next initial program load (IPL) and persistently preserve the deconfiguration state. Such computer systems also have the ability for some hardware items to be deallocated while at runtime, depending on hardware, hypervisor, and operating system support. These runtime deallocations also have a corresponding IPL deconfiguration that is stored persistently.

Currently reasons for hardware deconfiguration include two classifications, fatal and predictive. Fatal deallocation reasons occurring at runtime and IPL are when diagnostics determine that the hardware has failed to the point where data corruption or unexpected system downtime has already occurred or is very likely to happen in the near future. Predictive deallocation reasons are when diagnostics determines that the hardware is at an elevated risk of data corruption or unexpected downtime. In both cases, the hardware item then is IPL deconfigured and, if the system supports, runtime deconfiguration will occur.

When a runtime deconfiguration event is detected by diagnostics, the firmware will inform the hypervisor of a runtime deconfiguration request. The hypervisor, by working with the operating system partitions using that hardware, will attempt to free the hardware. If the hypervisor has a spare hardware item of the same type, due to Capacity Upgrade On-Demand spares or hardware not currently assigned to a partition, the hypervisor will begin using the spare instead of the runtime deallocated part.

There are certain classifications of hardware failures, which do not fit into the current two classes. In many cases, hardware items can fail in such a way that they have no increased risk of data corruption or system downtime, but by continuing to use the hardware item the system is placed in a degraded performance mode. There are also some predictive failures that can be healed by diagnostic firmware but after the healing the hardware item causes a degraded performance mode.

Currently, we have two choices for classifying these problems: a predictive deconfiguration or no deconfiguration. In both cases a service event is created to replace the performance degraded hardware item. Either way these problems are classified, a negative system impact results for some of our customers.

If the failure is classified as a predictive deconfiguration and the customer does not have any spare hardware, that hardware item is removed and causes a great reduction in system performance. If the failure is classified as a no deconfiguration and the customer has spare hardware, the use of a performance degraded part is continued even though the customer has fully performing spare parts available in their system for use.

U.S. Pat. No. 5,951,686 issued Sep. 14, 1999, entitled “Method and System for Reboot Recovery” to McLaughlin et al., and assigned to the present assignee discloses a computer system with reboot capability includes a processing mechanism, the processing mechanism supporting an operating system. The system includes a service processor coupled to the processing mechanism, the service processor determining whether a reboot operation is needed and a memory mechanism coupled to the processing mechanism and the service processor, the memory mechanism storing a plurality of platform policy parameters and an automatic restart policy of the operating system to support the reboot operation of the service processor.

U.S. Patent Publication No. 2005/0229039 A1 published Oct. 13, 2005, entitled “Method for fast system recovery via degraded reboot” to Anderson et al., and assigned to the present assignee discloses a system and method for fast system recovery that bypasses diagnostic routines by disconnecting failed hardware from the system before rebooting. Failed hardware and hardware that will be affected by removal of the failed hardware of the system are disconnected from the system. The system is restarted, and because the failed hardware is disconnected, diagnostic routines may safely be eliminated from the reboot process.

A need exists for an effective mechanism to rectify these two conditions so that all customers, with or without spare hardware, will have the maximum performance possible when their system experiences a performance degrading hardware failure.

### SUMMARY OF THE INVENTION

Principal aspects of the present invention are to provide a method, apparatus and computer program product for implementing enhanced performance of a computer system with partially degraded hardware. Other important aspects of the present invention are to provide such method, apparatus and computer program product for implementing enhanced performance of a computer system with partially degraded hardware substantially without negative effect and that overcome many of the disadvantages of prior art arrangements.

In brief, a method, apparatus and computer program product are provided for implementing enhanced performance of a computer system with partially degraded hardware. A performance deconfiguration event is identified for a hardware item. The hardware item is marked in a performance deconfiguration state. When there is at least one fully working spare available for the hardware item of the performance deconfiguration event, then a fully working spare is activated.

In accordance with features of the invention, the hardware item is moved to a performance degraded HW pool after the fully working spare is activated. When a nonfunctional deconfiguration event for a failed hardware item is identified and there is at least one fully working spare available, then a fully working spare is activated for the failed hardware item. The failed hardware part is moved to a nonfunctional HW pool. Otherwise, if there are no fully working spares, and there is at least one performance degraded spare available, then activity is migrated to this performance degraded spare. The deallocated part is moved to the nonfunctional HW pool.

### BRIEF DESCRIPTION OF THE DRAWINGS

The present invention together with the above and other objects and advantages may best be understood from the following detailed description of the preferred embodiments of the invention illustrated in the drawings, wherein:

FIGS. 1A and 1B are block diagram representations illustrating an exemplary computer system for implementing enhanced performance of the computer system with partially degraded hardware in accordance with the preferred embodiment;

FIGS. 2 and 3 are flow charts illustrating exemplary steps for implementing enhanced performance of the computer system with partially degraded hardware including respectively an IPL flow with diagnostics and a runtime failure flow in accordance with the preferred embodiment;

FIG. 4 is a block diagram illustrating a computer program product in accordance with the preferred embodiment.

### DETAILED DESCRIPTION OF THE PREFERRED EMBODIMENTS

In accordance with features of the invention, a method provides a new classification of deconfiguration events called performance deconfiguration. The system firmware or hypervisor stores a flag for each hardware item that identifies if the hardware item is in a performance deconfiguration state due to a past failure. When diagnostics manager determines a performance degrading failure, a request is issued for the hardware item to be marked performance deconfigured. If that hardware item supports a runtime deallocation, the hypervisor will be informed of this performance deconfiguration event. A method is provided for the hypervisor to ensure a maximum performance configuration when there have been IPL or runtime performance deconfiguration events.

In accordance with features of the invention, for example, a new flag in system firmware is associated with each hardware item to identify performance deconfiguration. This new flag is provided in addition to the flags already existing to identify other deconfiguration modes. Since other deconfiguration modes constitute a risk of data corruption or system downtime, if the hardware item is in one of these other modes and a performance deconfiguration mode at the same time, the performance deconfiguration should be ignored and pre-existing behavior for the higher priority deconfiguration mode should be done.

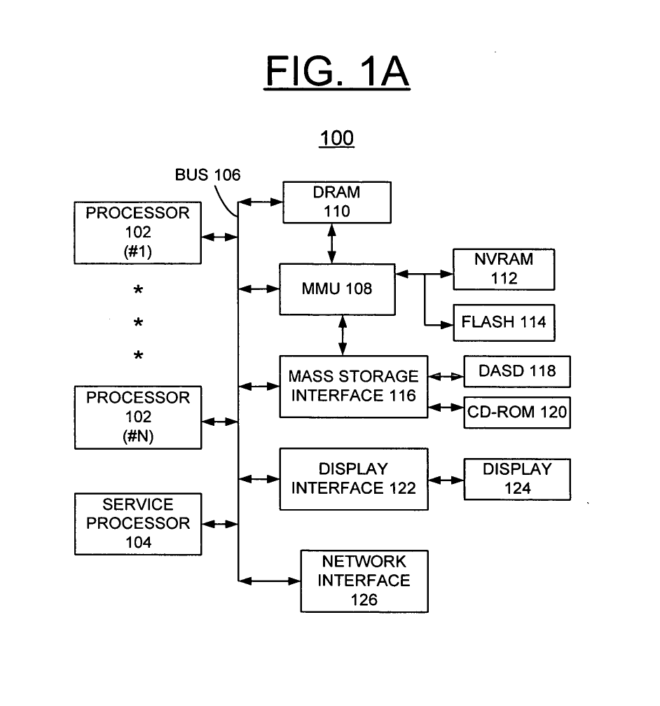

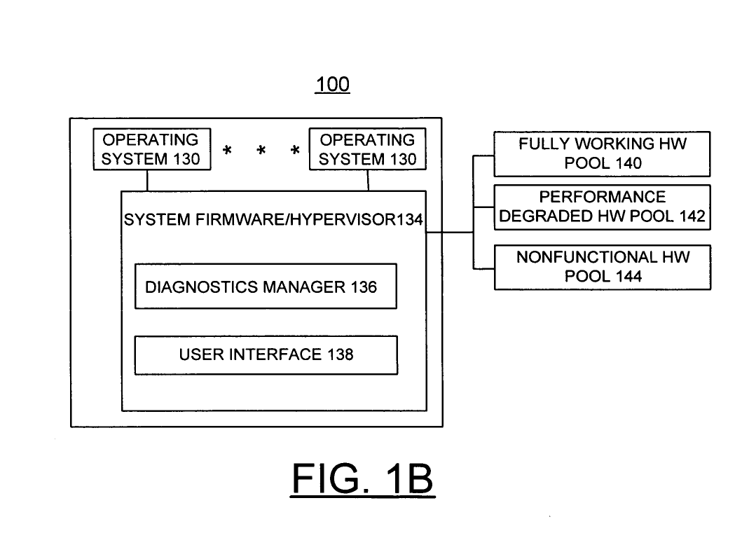

Referring now to the drawings, in FIGS. 1A and 1B there is shown an exemplary computer system generally designated by the reference character 100 for implementing enhanced performance of the computer system with partially degraded hardware in accordance with the preferred embodiment. Computer system 100 includes a plurality of processors 102, #1-N or central processor units (CPUs) 102, #1-N and a service processor 104 coupled by a system bus 106 to a memory management unit (MMU) 108 and system memory including a dynamic random access memory (DRAM) 110, a nonvolatile random access memory (NVRAM) 112, and a flash memory 114. The system bus 106 may be private or public, and it should be understood that the present invention is not limited to a particular bus topology used. A mass storage interface 116 coupled to the system bus 106 and MMU 108 connects a direct access storage device (DASD) 118 and a CD-ROM drive 120 to the main processor 102. Computer system 100 includes a display interface 122 connected to a display 124, and a network interface 126 coupled to the system bus 106.

Computer system 100 is shown in simplified form sufficient for understanding the present invention. The illustrated computer system 100 is not intended to imply architectural or functional limitations. The present invention can be used with various hardware implementations and systems and various other internal hardware devices.

As shown in FIG. 1B, computer system 100 includes a plurality of operating system 130, and a system firmware or hypervisor 134 including a diagnostics manager 136 of the preferred embodiment, and a user interface 138. A fully functional hardware pool 140, a performance degraded hardware pool 142, and a nonfunctional hardware pool 144 are maintained by the system firmware 134 and diagnostics manager 136 in accordance with the preferred embodiment.

In accordance with features of the invention, there are three hardware states: fully good or fully working, performance degraded, and non-functional. On IPL, the system firmware or hypervisor 134, initializes hardware in classes: processors, memory, IO paths, and the like. For each of these classes, the customer has a specific amount of licensed hardware or hardware that is not unlicensed and that is not set to be spare. The software or system firmware 134 attempts to fulfill licensed hardware first from the fully working HW pool 140 and then from the performance degraded pool 142. If the software or system firmware 134 cannot fulfill licensed hardware from these two pools 140,142, it does not attempt to use hardware from the non-functional pool 144.

In accordance with features of the invention, if a deallocation event, of any type, occurs at runtime and the hardware type does not support runtime deallocation, then the deallocation is delayed until the next IPL.

In accordance with features of the invention, when runtime deallocation is supported, and when the deallocation is a performance deconfiguration event and there are fully working spares available, then all activity is migrated to the fully working spare. The deallocated part is moved to the performance degraded HW pool 142. Otherwise, if there are no fully working spares, then there is no change in allocation. The deallocated part is moved to the performance degraded HW pool 142.

In accordance with features of the invention, when the deallocation is a non-function deconfiguration event and there are fully working spares available, then all activity is migrated to the fully working spare. The deallocated part is moved to the nonfunctional HW pool 144. Otherwise, if there are no fully working spares, and there are performance degraded spares available, then all activity is migrated to this spare. The deallocated part is moved to the nonfunctional HW pool 144. If there are no spares, then currently existing runtime deallocation procedures are followed that generally includes attempting to free or evacuate the failed hardware and then moving deallocated part to the nonfunctional HW pool 144.

In accordance with features of the invention, the methods of the invention ensure that parts from the fully working HW pools 140 are used first, which are guaranteed of maximum performance. Then performance degraded parts are used, which gives better performance than completely deconfiguring these parts. The methods of the invention ensure that in the event of a hardware failure, the system 100 continues to run in the maximum performance mode that can be provided, with the degraded hardware, without any increased risk of data corruption or system downtime.

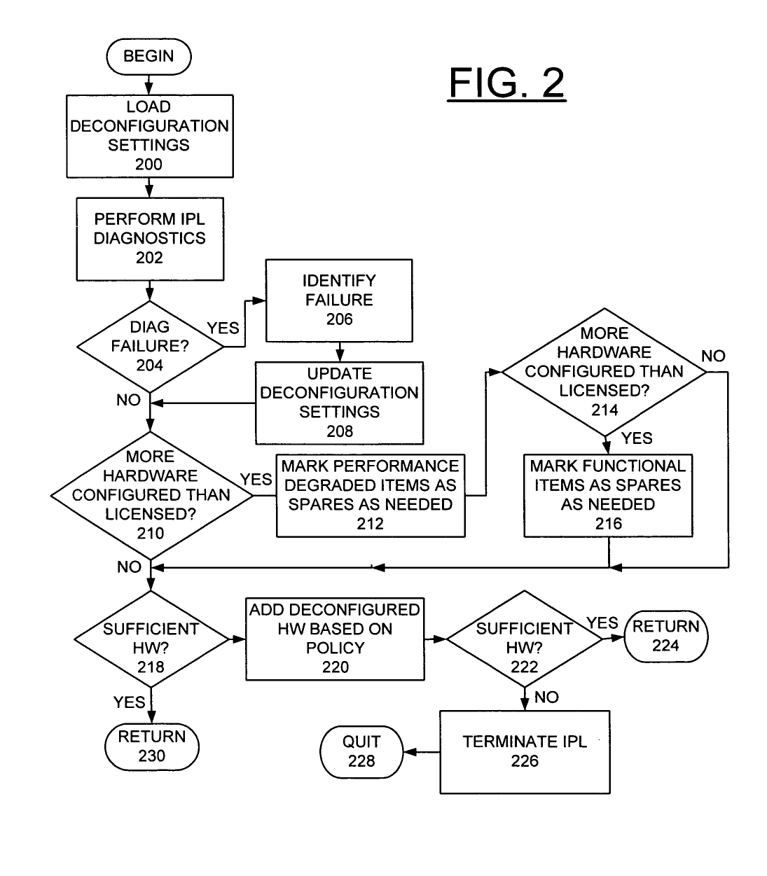

Referring now to FIG. 2, there are shown exemplary steps of an IPL flow with diagnostics for implementing enhanced performance of the computer system 100 with partially degraded hardware in accordance with the preferred embodiment. First deconfiguration settings are loaded as indicated in a block 200. IPL diagnostics are performed as indicated in a block 202. When a diagnostics failure is found as indicated in a decision block 204, the type of failure for the failed hardware is identified as indicated in a block 206. The deconfiguration settings are updated as indicated in a block 208, for example, the failed hardware is added to either the performance degraded hardware pool 142, or the nonfunctional hardware pool 144 based upon the type of failure for the failed hardware.

Checking for more hardware configured than licensed is performed as indicated in a decision block 210. When more hardware is configured than licensed, then performance degraded hardware items are marked as spares as indicated in a block 212. Again checking for more hardware configured than licensed is performed as indicated in a decision block 214. When more hardware is configured than licensed, then functional hardware items are marked as spares as indicated in a block 216.

Then checking for sufficient hardware is performed as indicated in a decision block 218, after marking spares at block 212 and 216 or when determined at decision block 210 that less hardware is configured than licensed. When insufficient hardware is identified, then as indicated in a block 220 deconfigured HW is added based upon policy in accordance with the invention where parts from the fully working HW pools 140 are used first, which are guaranteed of maximum performance, and then if needed performance degraded parts are used from the performance degraded HW pools 142, which provides better performance than completely deconfiguring these parts.

Then checking for sufficient hardware is performed as indicated in a decision block 222. When sufficient hardware is identified, then the operations return to the IPL as indicated in a block 224. When sufficient hardware is not identified, then the IPL is terminated as indicated in a block 226, and the operations quit as indicated in a block 228. When sufficient hardware is identified at decision block 218, then the operations return to the IPL as indicated in a block 230.

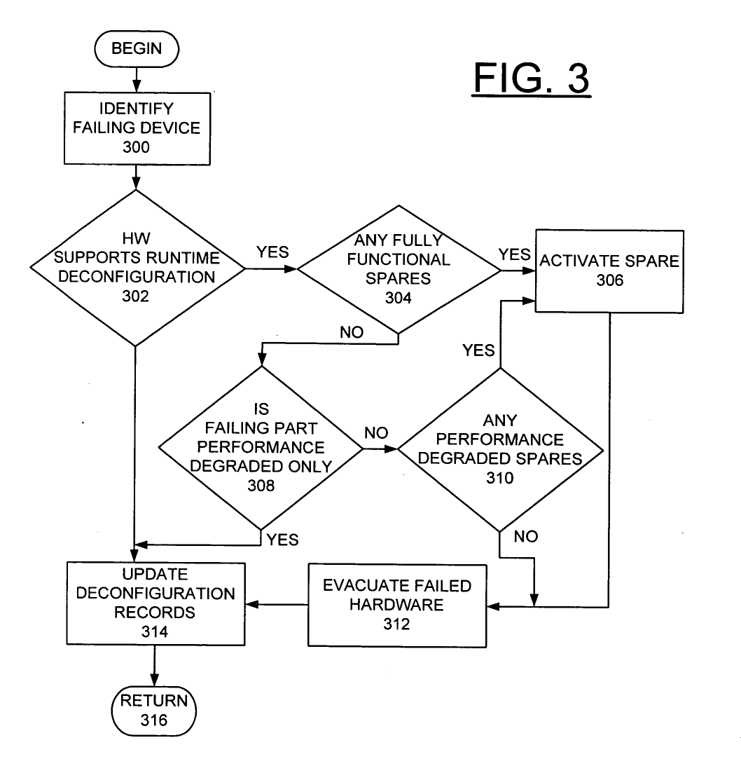

Referring now to FIG. 3, there are shown exemplary steps of a runtime failure flow for implementing enhanced performance of the computer system 100 with partially degraded hardware in accordance with the preferred embodiment. A failing device is identified as indicated in a block 300. Checking whether HW supports runtime deconfiguration as indicated in a decision block 302. When HW supports runtime deconfiguration, then checking for fully functional spares is performed as indicated in a decision block 304. When a fully functional spare is identified, then the fully functional spare is activated as indicated in a block 306.

Otherwise when a fully functional spare is not identified, then checking whether the failing part is performance degraded only as indicated in a block 308. When the failing part is not performance degraded only, then checking for performance degraded spares is performed as indicated in a decision block 310.

When a performance degraded spare is identified at block 310, then the performance degraded spare is activated at block 306. When a performance degraded spare is not identified at block 310, or after the particular spare is activated at block 306 then the failed hardware is evacuated as indicated in a block 312.

After the failed hardware is evacuated at block 312, or when determined that runtime deconfiguration is not supported at block 302, or when determined that the failing part is a performance degraded part at block 308, then the deconfiguration records are updated as indicated in a block 314 and the operations return or continue as indicated in a block 316. The updated deconfiguration records are loaded with the next IPL at block 200 in FIG. 2.

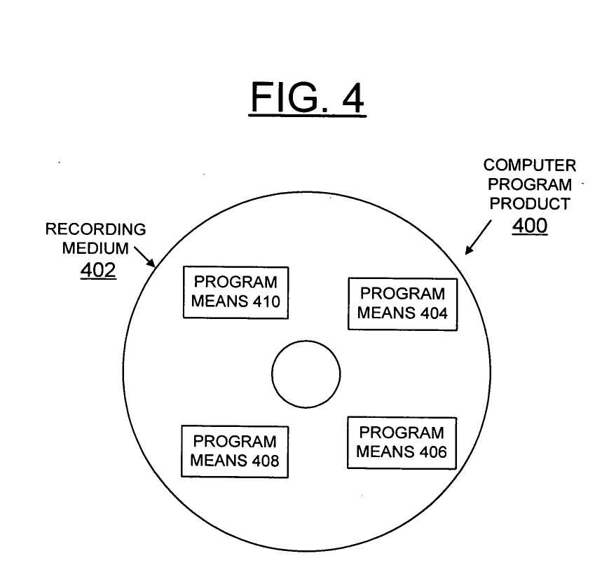

Referring now to FIG. 4, an article of manufacture or a computer program product 400 of the invention is illustrated. The computer program product 400 includes a recording medium 402, such as, a floppy disk, a high capacity read only memory in the form of an optically read compact disk or CD-ROM, a tape, a transmission type media such as a digital or analog communications link, or a similar computer program product. Recording medium 402 stores program means 404, 406, 408, 410 on the medium 402 for carrying out the methods for implementing enhanced performance with partially degraded hardware of the preferred embodiment in the computer system 100 of FIGS. 1A and 1B.

A sequence of program instructions or a logical assembly of one or more interrelated modules defined by the recorded program means 404, 406, 408, 410, direct the computer system 100 for implementing enhanced performance with partially degraded hardware of the preferred embodiment.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

While the present invention has been described with reference to the details of the embodiments of the invention shown in the drawing, these details are not intended to limit the scope of the invention as claimed in the appended claims.

What is claimed is:

1. A computer-implemented method for implementing enhanced performance of a computer system with partially degraded hardware comprises the steps of:
identifying a performance deconfiguration event for a hardware item;
marking said hardware item in a performance deconfiguration state responsive to said performance deconfiguration event;
checking for a fully functional spare for said hardware item;
responsive to identifying said fully functional spare for said hardware item, activating said fully functional spare for said hardware item.

2. The computer-implemented method as recited in claim 1 wherein identifying a performance deconfiguration event for said hardware item includes identifying degraded performance for said hardware item.

3. The computer-implemented method as recited in claim 2 wherein the computer system supports runtime deconfiguration and wherein activating said fully functional spare for said hardware item is performed during system runtime responsive to identifying degraded performance for said hardware item during system runtime.

4. The computer-implemented method as recited in claim 2 wherein runtime deconfiguration is not supported in the computer system and wherein marking said hardware item in a performance deconfiguration state responsive to said performance deconfiguration event is performed during system runtime; and activating said fully functional spare for said hardware item is performed during an initial program load (IPL).

5. The computer-implemented method as recited in claim 1 wherein activating said fully functional spare for said hardware item includes migrating activity from said hardware item to said fully functional spare.

6. The computer-implemented method as recited in claim 1 includes responsive to failing to identify a fully functional spare for said hardware item, continuing operation with said hardware item.

7. The computer-implemented method as recited in claim 1 further includes identifying a nonfunctional deconfiguration event for a failed hardware item; and responsive to failing to identify a fully functional spare for said failed hardware item, checking for a spare hardware in said performance deconfiguration state for said failed hardware item.

8. The computer-implemented method as recited in claim 7 further includes responsive to identifying said spare hardware in said performance deconfiguration state for said failed hardware item, activating said spare hardware in said performance deconfiguration state for said failed hardware item.

9. The computer-implemented method as recited in claim 1 further includes responsive to activating said fully functional spare for said hardware item, evacuating said failed hardware item.

10. Apparatus for implementing enhanced performance of a computer system with partially degraded hardware comprises:
system firmware for maintaining a fully functional hardware pool, a performance deconfiguration hardware pool; and a nonfunctional hardware pool;
said system firmware including a diagnosis program for identifying a performance deconfiguration event for a hardware item;
said system firmware for checking said fully functional hardware pool for a fully functional spare for said hardware item;
said system firmware, responsive to identifying said fully functional spare for said hardware item, for activating said fully functional spare for said hardware item, and for moving said hardware item to said performance deconfiguration hardware pool.

11. The apparatus as recited in claim 10 wherein said system firmware, responsive to failing to identify a fully functional spare for said hardware item, for continuing operation with said hardware item.

12. The apparatus as recited in claim 10 wherein said system firmware marks said hardware item in a performance deconfiguration state responsive to said performance deconfiguration event.

13. The apparatus as recited in claim 10 wherein said system firmware including said diagnosis program for identifying a nonfunctional deconfiguration event for a failed hardware item; responsive to failing to identify a fully functional spare for said failed hardware item, checking said performance deconfiguration hardware pool for a spare hardware for said failed hardware item; and responsive to identifying said spare hardware in said performance deconfiguration hardware pool, activating said spare hardware for said failed hardware item.

14. The apparatus as recited in claim 12 wherein said system firmware moves said failed hardware item to said nonfunctional hardware pool responsive to activating said spare hardware for said failed hardware item.

15. A computer program product for implementing enhanced performance of a computer system with partially degraded hardware, said computer program product including instructions executed by the computer system to cause the computer system to perform the steps comprising:
identifying a performance deconfiguration event for a hardware item;
marking said hardware item in a performance deconfiguration state responsive to said performance deconfiguration event;
checking for a fully functional spare for said hardware item;
responsive to identifying said fully functional spare for said hardware item, activating said fully functional spare for said hardware item.

16. The computer program product as recited in claim 15 further comprises identifying a nonfunctional deconfiguration event for a failed hardware item; and responsive to failing to identify a fully functional spare for said failed hardware item, checking for a spare hardware in said performance deconfiguration state for said failed hardware item.

17. The computer program product as recited in claim 15 further comprises responsive to identifying said spare hardware in said performance deconfiguration state for said failed hardware item, activating said spare hardware in said performance deconfiguration state for said failed hardware item, and evacuating said failed hardware item.

18. The computer program product as recited in claim 15 wherein activating said fully functional spare for said hardware item includes migrating activity from said hardware item to said fully functional spare, and moving said hardware item to a performance deconfiguration hardware pool.

19. The computer program product as recited in claim 15 wherein activating said fully functional spare for said hardware item is performed during an initial program load (IPL).

20. A method for deploying computing infrastructure, comprising integrating computer readable code into a computing system, wherein the code in combination with the computing system is capable of performing the method of claim 1.
